(19) United States
(12) Patent Application Publication
(10) Pub. No.: US 2025/0135678 A1
(43) Pub. Date: May 1, 2025

(54) SAWING DEVICE

(71) Applicant: Ethan Andersen, Bondurant, IA (US)

(72) Inventor: Ethan Andersen, Bondurant, IA (US)

(21) Appl. No.: 18/932,022

(22) Filed: Oct. 30, 2024

Related U.S. Application Data
(60) Provisional application No. 63/594,715, filed on Oct. 31, 2023.

(51) Int. Cl. B27B 5/29; B23D 59/00; B27B 27/08

(52) U.S. Cl. CPC B27B 5/29; B23D 59/001; B23D 59/0064; B27B 27/08

(57) ABSTRACT

A device may include a housing assembly that at least partially encloses a blade assembly. A device may include an actuation assembly operatively connected to the blade assembly to move the blade assembly in a linear direction along a substantially horizontal plane. A device may have a fence assembly having portions rotatably connected to one another. A device may have a measuring assembly to set a measurement of a cut. A device may have a hood assembly to cover a material during operation and having a translucent portion to allow sight of the material during operation. A device may have a clamp assembly to selectively restrain the material during operation by applying a downward force on the material.

### CROSS REFERENCE TO RELATED APPLICATION

This application claims the benefit U.S. provisional application Ser. No. 63/594,715 filed Oct. 31, 2023, the contents of this applications is hereby incorporated by reference in their entirety.

### BACKGROUND OF THE INVENTION

This disclosure generally relates to a sawing device. More specifically, the disclosure relates to a sawing device for crosscutting material, e.g., wooden boards.

Woodworking has been a captivating pursuit for countless individuals across the globe and throughout history. The ingenuity and creativity that goes into creating beautiful pieces of furniture and art have long fascinated enthusiasts and professionals alike. As a dynamic and evolving field, woodworking continually benefits from innovative tools and solutions that cater to the needs of woodworkers.

A common task in woodworking is crosscutting boards, which involves cutting boards, predominantly across their grain, to create a piece of wood of a specific length. This seemingly simple task can be quite challenging, particularly when it comes to making precise cuts that are square, clean, and accurate. Many woodworkers have struggled to find effective solutions for this job in their own workshops, leading to a curiosity about how others have accomplished this task and the history of cross-cutting boards.

Table saws with crosscut sleds are a popular choice for cross cutting boards because they provide accurate cuts and have the ability to handle large pieces of material. However, they can be cumbersome to set up and take down. Such devices also have a significant footprint, occupying large areas in a workshop. This is particularly problematic for smaller woodworking shops that have limited space.

Miter saws are also a common tool for cross cutting boards, but they often struggle with accuracy, especially when making repeated cuts of the same length. Additionally, they have limited crosscut capacity (i.e., the maximum distance the miter saw can travel across a piece of material to accomplish a cut), which can be problematic when working with wider boards.

Up cut saws are typically used in industrial settings, where they excel at quickly and accurately cutting large quantities of material. However, they require a significant amount of space and are not well-suited for smaller scale woodworking. The crosscut capacity of an upcut saw is also defined by the diameter of the saw blade due to the blade travelling in a perpendicular direction in relation to a length of the board. As such, to accomplish a cross cut of material with a large width, the saw blade must be very large and therefore heavy and expensive.

Finally, radial arm saws used to be a popular tool for crosscutting. The large footprint required and safety risks associated with their use has led to these devices falling out of favor.

There is also a continuous desire to increase safety during use and avoid tear out from a cut. Injuries involving power tools and saw devices generally can arise from a variety of circumstances. The most apparent is injury resulting from contacting a saw blade. Injuries more commonly occur from kickback, which is when a piece of material comes loose during a cut and thereafter contacts the saw blade and is ejected at a high speed causing significant harm if the projectile hits an individual. Tear out occurs as the saw blade exits a cut and pulls the grain of a material causing splintering. The splintering leaves a rough edge rather than a clean cut that is desired.

Accordingly, there is no one sawing device that encompasses all the desirable features involved in crosscutting. Thus, it is a primary aspect of this disclosure to provide a sawing device that improves upon the art, including by way of achieving one or more of the following advantageous aspects.

Another aspect of this disclosure is to provide a sawing device that has a small footprint.

Yet another aspect of this disclosure is to provide a sawing device that can be carried by a single individual.

Another aspect of this disclosure is to provide a sawing device that is designed for transport.

Yet another aspect of this disclosure is to provide a sawing device that is precise.

Another aspect of this disclosure is to provide a sawing device that is accurate.

Yet another aspect of this disclosure is to provide a sawing device that is precise and accurate during repeated cuts.

Another aspect of this disclosure is to provide a sawing device that is accurate during long crosscuts.

Yet another aspect of this disclosure is to provide a sawing device that reduces movement of a material during a cut.

Another aspect of this disclosure is to provide a sawing device that reduces or eliminates tear out.

Yet another aspect of this disclosure is to provide a sawing device that accomplishes cuts at a desired length.

Another aspect of this disclosure is to provide a sawing device that increases maximum crosscut capacity will a small footprint.

Yet another aspect of this disclosure is to provide a sawing device that is easy to use.

Another aspect of this disclosure is to provide a sawing device that is cost-effective for all types of woodworkers.

Yet another aspect of this disclosure is to provide a sawing device that is safe and limits exposure to contact with a saw blade and reduces the potential for an injurious kickback.

Another aspect of this disclosure is to provide a sawing device that provides for linear actuation.

Yet another aspect of this disclosure is to provide a sawing device that captures dust.

These and other aspects, features, and advantages of the invention will become apparent from the specification and claims.

### SUMMARY OF THE INVENTION

The disclosure provides, broadly, various aspects of a sawing device.

In some aspects, the techniques described herein relate to a sawing device including: a housing assembly that partially encloses a blade assembly; and an actuation assembly operatively connected to the blade assembly to move the blade assembly in a linear direction along a substantially horizontal plane.

In some aspects, the techniques described herein relate to a sawing device further including the housing assembly having an enclosure with a cutting surface having a blade slit that a saw blade of the blade assembly is positioned through.

In some aspects, the techniques described herein relate to a sawing device further including a wing rotatably attached to an enclosure of the housing assembly, wherein the wing is configured to transition between a collapsed position wherein the wing engages a side of the enclosure and an expanded position wherein the wing extends in alignment with a cutting surface of the enclosure.

In some aspects, the techniques described herein relate to a sawing device further including a support positioned between the wing and the side of the enclosure wherein the wing is held in the expanded position by the support.

In some aspects, the techniques described herein relate to a sawing device further including the blade assembly having a carriage, a motor, and a saw blade, wherein the motor is mounted to the carriage and the saw blade is operatively attached to the motor.

In some aspects, the techniques described herein relate to a sawing device further including the actuation assembly having an actuator connected to the blade assembly at a first end and an actuation control at a second end, wherein the actuator is configured to move linearly away from the actuation control upon rotation of the actuation control in a downward direction.

In some aspects, the techniques described herein relate to a sawing device further including a bias assembly connected to the actuation assembly, wherein the bias assembly is configured with a bias against a direction of linear movement of the actuator.

In some aspects, the techniques described herein relate to a sawing device further including the actuation assembly having a blade path system that slidably receive a carriage mount connected to the carriage of the blade assembly.

In some aspects, the techniques described herein relate to a sawing device further including a fence assembly connected to the housing assembly.

In some aspects, the techniques described herein relate to a sawing device further including the fence assembly having a first fence portion that is rotatably attached to a second fence portion of the fence assembly such that the first fence portion is rotatable radially at least 135° about a connection between the first fence portion and the second fence portion.

In some aspects, the techniques described herein relate to a sawing device further including the fence assembly having a fence lock configured to lock the first fence portion in position.

In some aspects, the techniques described herein relate to a sawing device further including the fence assembly having a sacrificial mount that replaceably receives a sacrificial insert.

In some aspects, the techniques described herein relate to a sawing device further including the fence assembly having a measuring assembly attached to a fence portion, and the measuring assembly having a tape that retractably attaches between a stop and the fence portion, wherein the stop is configured to be received over an end of a material.

In some aspects, the techniques described herein relate to a sawing device further including a display connected to the housing assembly, wherein the display is configured to display a length of a desired cut.

In some aspects, the techniques described herein relate to a sawing device further including a hood assembly hingedly attached to the housing assembly.

In some aspects, the techniques described herein relate to a sawing device further including a fence assembly positioned between the hood assembly and the housing assembly.

In some aspects, the techniques described herein relate to a sawing device further including the hood assembly having a hood having a window assembly included of a first hood portion, a window, and a second hood portion that each extend from a front wall to a rear wall of the housing assembly.

In some aspects, the techniques described herein relate to a sawing device further including the hood assembly having a clamp assembly that extends between the hood assembly and the housing assembly.

In some aspects, the techniques described herein relate to a sawing device further including the blade assembly having a saw blade, wherein the saw blade is rotatable downwardly and rearwardly with respect to a front wall and top wall of the housing assembly, wherein when the saw blade engages a material the saw blade pulls the material downward against the top wall of the housing assembly and towards a fence assembly connected to the housing assembly.

In some aspects, the techniques described herein relate to a sawing device further wherein when the saw blade engages the material a dust from the material is directed rearwardly against the fence assembly between a hood assembly and the housing assembly such that the dust is captured within the housing assembly.

This has outlined, rather broadly, the features, advantages, solutions, and benefits of the disclosure in order that the description that follows may be better understood. Additional features, advantages, solutions, and benefits of the disclosure will be described in the following. It should be appreciated by those skilled in the art that this disclosure may be readily utilized as a basis for modifying or designing other structures and related operations for carrying out the same purposes of the present disclosure. It should also be realized by those skilled in the art that such equivalent constructions and related operation do not depart from the teachings of the disclosure as set forth in the appended claims. The novel features, together with further objects and advantages, will be better understood from the following description when considered in connection with the accompanying Figures. It is to be expressly understood, however, that each of the Figures is provided for the purpose of illustration and description only and is not intended as a definition of the limits of the present disclosure.

### BRIEF DESCRIPTION OF THE DRAWINGS

FIG. 1 is a perspective view of a sawing device according to an aspect of the disclosure;

FIG. 2 is a top view of a sawing device according to an aspect of the disclosure;

FIG. 3 is a front view of a sawing device according to an aspect of the disclosure;

FIG. 4 is a rear view of a sawing device according to an aspect of the disclosure;

FIG. 5 is a side view of a sawing device according to an aspect of the disclosure;

FIG. 6 is a perspective view of a sawing device according to an aspect of the disclosure;

FIG. 7 is a top view of a sawing device according to an aspect of the disclosure;

FIG. 8 is a front view of a sawing device according to an aspect of the disclosure;

FIG. 9 is a side view of a sawing device according to an aspect of the disclosure;

FIG. 10 is a perspective view of a sawing device according to an aspect of the disclosure;

FIG. 11 is a top view of a sawing device according to an aspect of the disclosure;

FIG. 12 is a side view of a sawing device according to an aspect of the disclosure;

FIG. 13A is a top side view of a sawing device according to an aspect of the disclosure;

FIG. 13B is a side, cross-sectional view of a sawing device along line A-A shown in FIG. 13A according to an aspect of the disclosure;

FIG. 14A is a top side view of a sawing device according to an aspect of the disclosure;

FIG. 14B is a front, cross-sectional view of a sawing device along line A-A shown in FIG. 14A according to an aspect of the disclosure;

FIG. 15 is a top, interior view of a sawing device according to an aspect of the disclosure;

FIG. 16 is a top view of a sawing device according to an aspect of the disclosure;

FIG. 17 is a perspective view of a sawing device according to an aspect of the disclosure;

FIG. 18 is a perspective, partial view of a sawing device according to an aspect of the disclosure;

FIG. 19 is a top view of a sawing device according to an aspect of the disclosure;

FIG. 20 is a perspective, partial view of a sawing device according to an aspect of the disclosure;

FIG. 21A is a perspective view of a sawing device according to an aspect of the disclosure;

FIG. 21B is a perspective view of a sawing device according to an aspect of the disclosure;

FIG. 22 is a perspective view of a sawing device according to an aspect of the disclosure;

FIG. 23 is a perspective view of a sawing device according to an aspect of the disclosure;

FIG. 24 is a perspective view of a sawing device according to an aspect of the disclosure; and

FIG. 25 is a perspective view of a prior art sawing device.

### DETAILED DESCRIPTION

The disclosure described herein is directed to different aspects of a sawing device. The detailed description set forth below, in connection with the appended drawings, is intended as a description of various configurations and is not intended to represent the only configurations in which the concepts described herein may be practiced. These descriptions include specific details for the purpose of providing a thorough understanding of the various concepts. It will be apparent, however, to those skilled in the art that these concepts may be practiced without these specific details. In some instances, well-known structures and components are shown in block diagram form to avoid obscuring such concepts.

The disclosure is described herein with reference to certain aspects, iterations, embodiments, and examples but it is understood that the disclosure can be embodied in many different forms and should not be construed as limited to the aspects set forth herein. In particular, the disclosure is described herein in regard to a device for making cuts and particularly crosscuts, but it is understood that aspects of the disclosure can improve other power tools to achieve similar advantages.

Although the terms first, second, etc. may be used herein to describe various elements or components, these elements or components should not be limited by these terms. These terms are only used to distinguish one element or component from another. Hence, a first element discussed herein could be termed a second element without departing from the teachings of the present application. It is understood that actual systems or fixtures embodying the disclosure can be arranged in many ways with many more features and elements beyond what is shown in the drawings. For the same or similar elements or features, the same reference numbers may be used throughout the disclosure.

It is to be understood that when an element or component is referred to as being “on” another element or component, it can be directly on the other element or intervening elements may also be present. Furthermore, relative terms such as “between”, “within”, “below”, and similar terms, may be used herein to describe a relationship of one element or component to another. It is understood that these terms are intended to encompass different orientations of the disclosure in addition to the orientation depicted in the figures.

Aspects of the disclosure may be described herein with reference to illustrations that are schematic illustrations. As such, the actual thickness of elements can be different, and variations from the shapes of the illustrations as a result, for example, of manufacturing techniques and/or tolerances are expected. Thus, the elements illustrated in the figures are schematic in nature and their shapes are not intended to illustrate the precise shape of a region of a device and are not intended to limit the scope of the disclosure.

With reference to the Figures aspects of a sawing device 10 are shown according to the disclosure. The sawing device 10 comprises one or more of a housing assembly 12, a blade assembly 14, an actuation assembly 16, a fence assembly 18, a measuring assembly 20, a hood assembly 22, and a clamp assembly 24. The actuation assembly 16 may be configured to operatively connect to the blade assembly 14 to move the blade assembly 14 in a linear direction along a substantially horizontal plane. The fence assembly 18 may be configured to adjust an angle of attack with respect to the blade assembly 14 and a material 26 (such as a wooden board) such that the material 26 may be cut at varying angles. The measuring assembly 20 may be configured to measure and display a length of the material 26 to be cut. The hood assembly 22 may be configured to cover the blade assembly 14 during operation to limit or prevent injury while permitting sight through the hood assembly 22 to the material 26 during operation of sawing device 10. The clamp assembly 24 may be configured to hold the material 26 statically by applying a force on the material 26 such that the material 26 may be held between the clamp assembly 24 and the housing assembly 12. The sawing device 10 may be sized and shaped to be carried by an individual without assistance and/or sized and shaped to fit on and within a conventional retail store shelf.

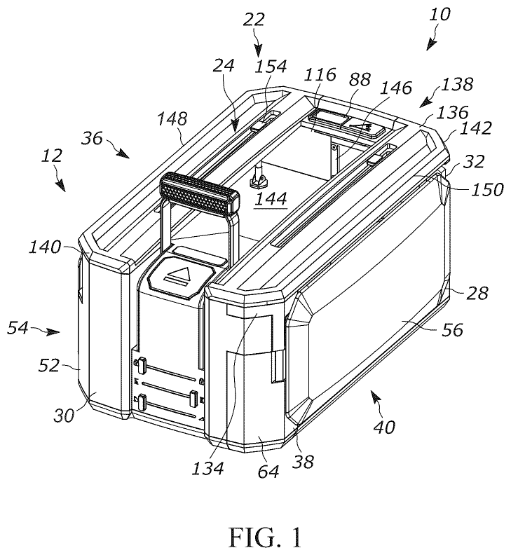

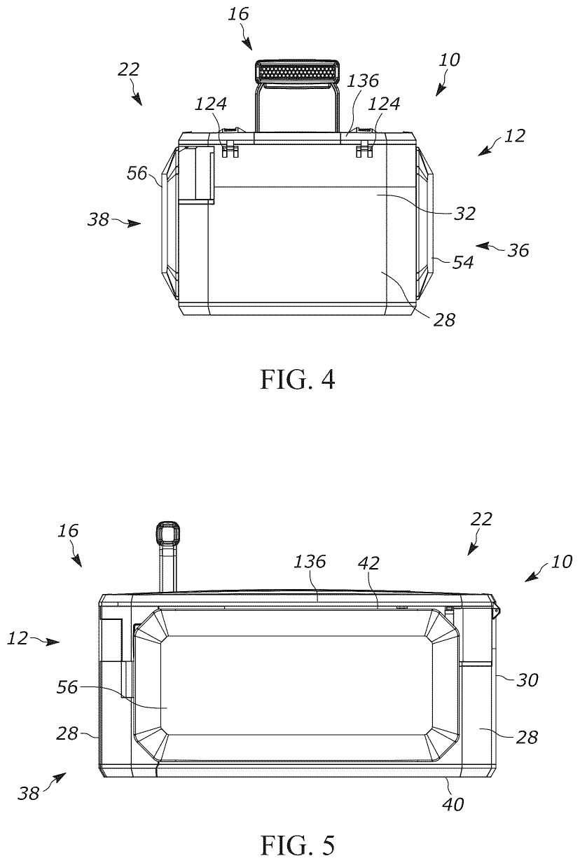

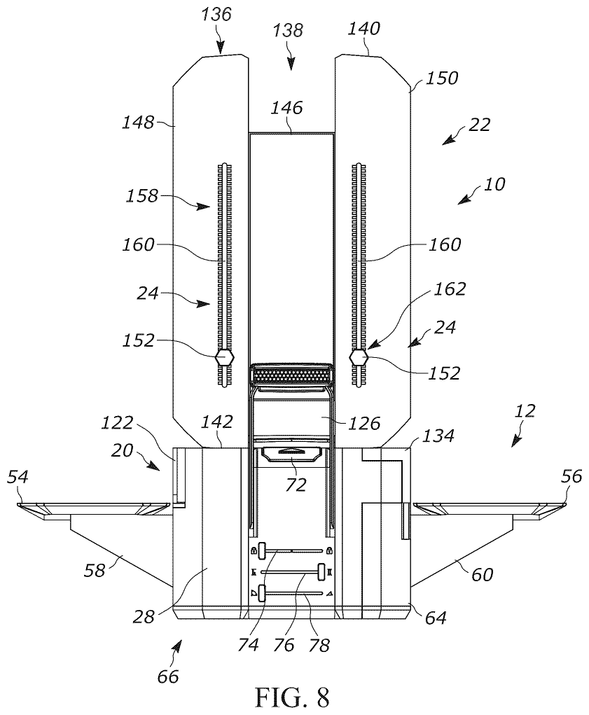

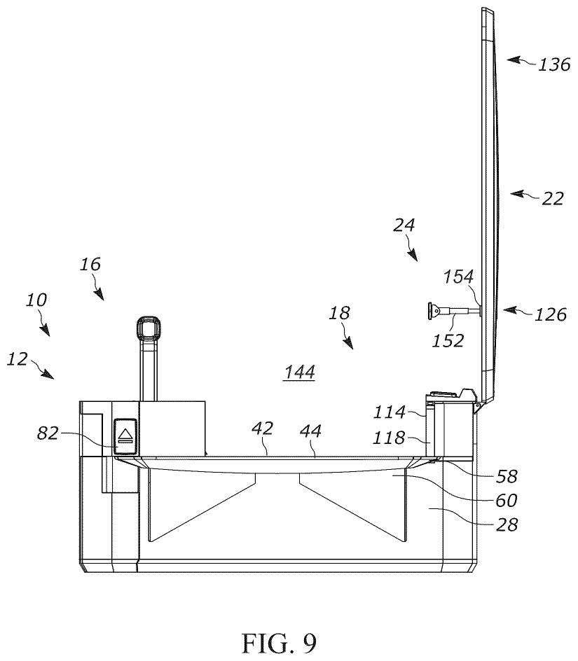

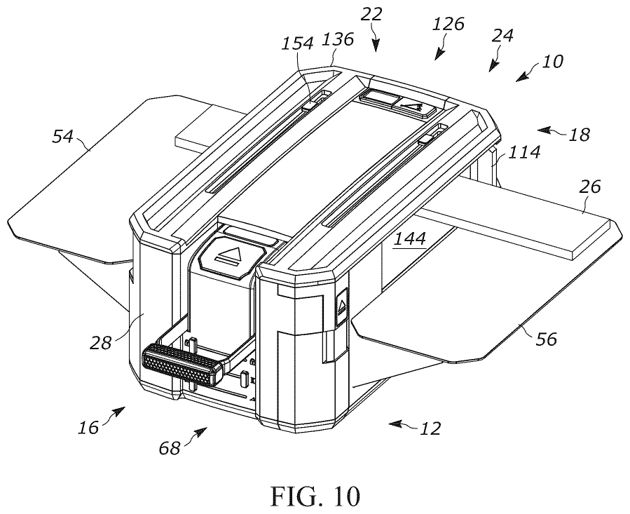

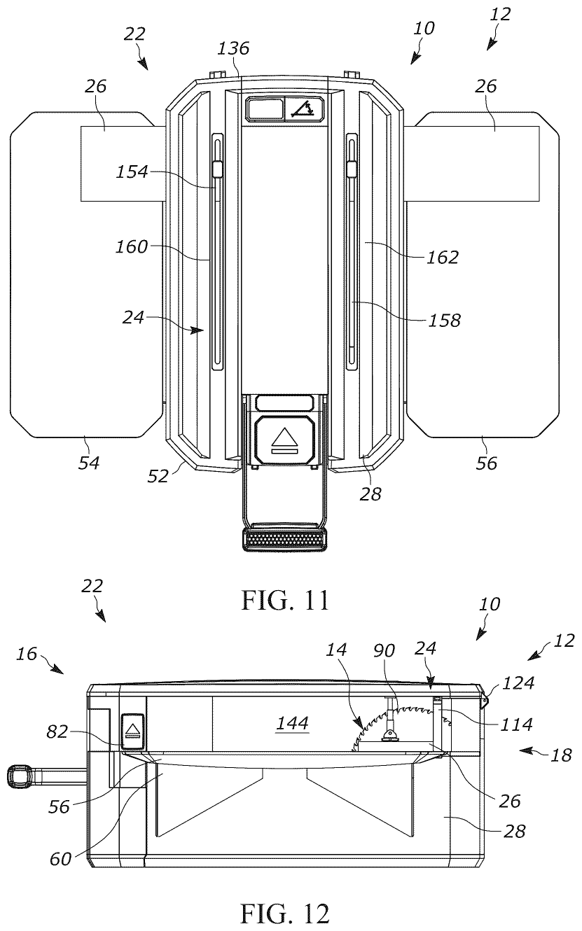

With reference to at least FIGS. 1-12, the housing assembly 12 may comprise an enclosure 28 formed by a front wall 30, a rear wall 32, a first side wall 36, a second side wall 38, a bottom wall 40, and a top wall 42. The enclosure 28 may enclose or partially enclose the blade assembly 14. The top wall 42 may have a cutting surface 44 that has a blade slit 46 that may receive or partially receive the blade assembly 14 and/or a dust 48 discharged from the material 26 during a cut.

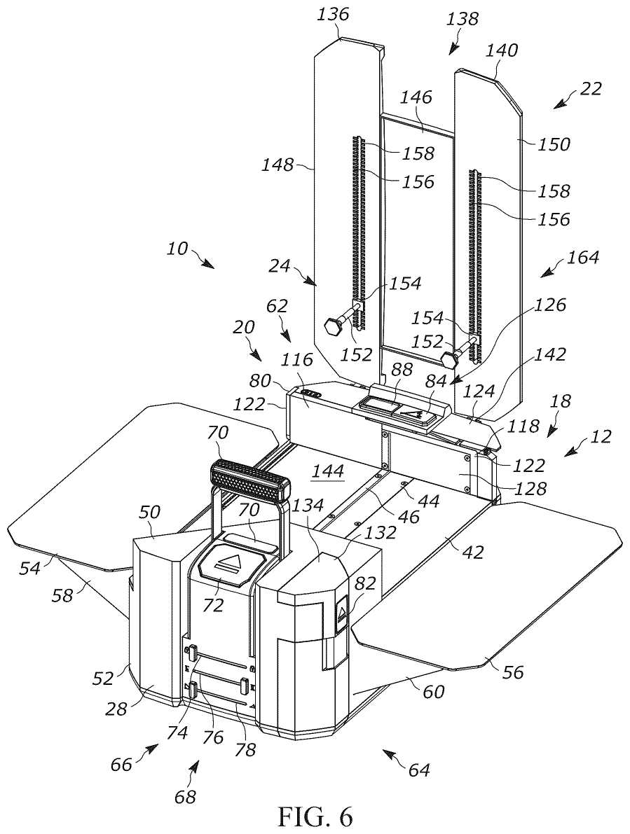

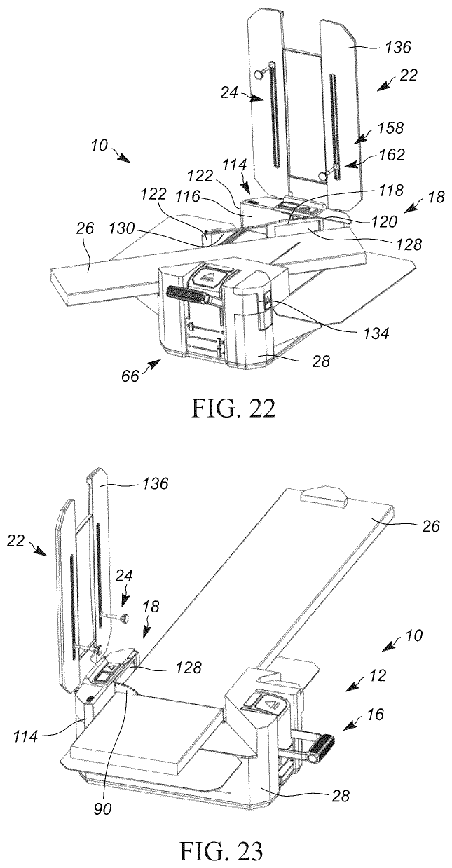

With reference to at least FIGS. 6, 7, and 22, a guide 50 may protrude from the top wall 42 such that the guide 50 rises above the cutting surface 44. The guide 50 may extend from a corner 52 of the housing assembly 12 to the blade slit 46. The guide 50 may extend from the blade slit 46 to the corner 52 at a 45° agree. The guide 50 may be configured to engage the material 26 to provide stability to the material 26 during an angled crosscut.

A wing 54 may be rotatably connected to the housing assembly 12. The wing 54 may be connected to first side wall 36 and/or a second wing 56 may be connected to the second side wall 38 of the enclosure 28. The wing 54 and/or the second wing 56 may be configured to transition between a collapsed position, as depicted in at least FIGS. 1-5, and an expanded position, as depicted in FIGS. 6-12. The transition between the collapsed position and the expanded may be accomplished folding the wing 54 and/or the second wing 56 about the rotatable connection to the housing assembly 12. The wing 54 and second wing 56 may be configured to support and stabilize the material 26 during a cut while also providing additional support when the material 26 is longer such as is depicted in at least FIGS. 19, 22, and 23.

A support 58 may be rotatably connected to the housing assembly 12. The support 58 may be connected to the first side wall 36 such that the support 58 is positioned between the wing 54 and the first side wall 36. A second support 60 may be connected to the second side wall 38 of the enclosure 28 such that the second support 60 is positioned between the second wing 56 and the second side wall 38. The support 58 and/or second support 60 may be configured to transition between a collapsed position, as depicted in FIGS. 1-5, and an expanded position, as depicted in FIGS. 6-12. The transition between the collapsed position and the expanded may be accomplished folding the support 58 and/or second support 60 about the connection to the housing assembly 12. The wing 54 and the second wing 56 may rotate about a horizontal axis whereas the support 58 and/or the second support 60 may rotate about a vertical axis.

With reference to at least FIG. 1, the housing assembly 12 may comprise a power source 62 configured to power the sawing device 10 including the blade assembly 14 and/or a vacuum 64 as well as other electric features and elements described herein. The vacuum 64 may be configured to provide a suction force to draw the dust 48 into the housing assembly 12.

With reference to at least FIGS. 1, 3, 6, 7, and 9, an interface 66 comprising one or a plurality of controls 68 may be positioned on the sawing device 10 including the housing assembly 12. The interface 66 may comprise a power switch 70 configured to power the blade assembly 14 on and off, a hood release 72 configured to allow the hood assembly 22 to be raised and/or lowered, a device lock 74 configured to prevent and permit activation of the sawing device 10, a blade height adjuster 76 configured to modify the height of the blade assembly 14, a blade angle adjuster 78 configured to modify the angle of the blade assembly 14 about a horizontal axis extending proximally and distally, a fence lock 80 configured to hold and release the current position of the fence assembly 18 and/or measuring assembly 20, a laser ejector 82 configured to release the measuring assembly 20 from a stowed position in the housing assembly 12, and/or a display toggle 84 configured to switch between different informational views of a display 86 operatively connected to the measuring assembly 20 as described herein.

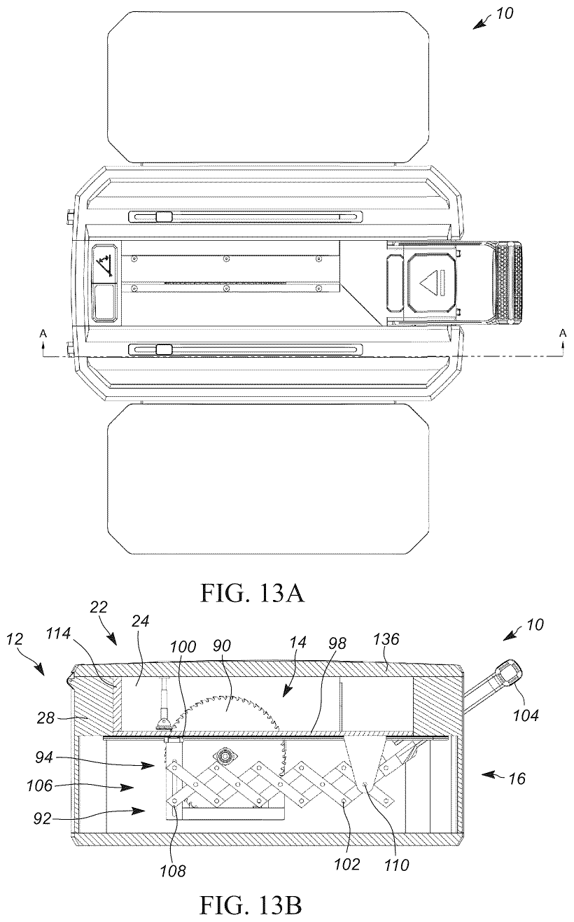

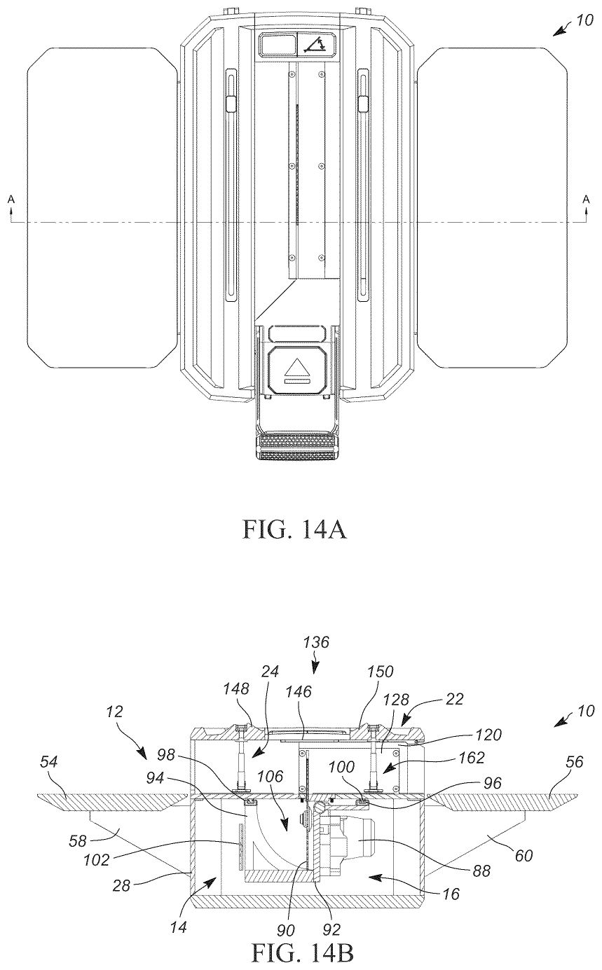

With reference to at least FIGS. 13A, 13B, 14A, and 14B, the blade assembly 14 may comprise one or more of a motor 88 operatively connected to a saw blade 90. The motor 88 and/or saw blade 90 may be mounted to and/or within a carriage 92, which may be configured as a trunnion 94 configured to modify the position of the saw blade 90. The saw blade 90 may be positioned through the blade slit 46 such the saw blade 90 is positioned within and without the enclosure 28.

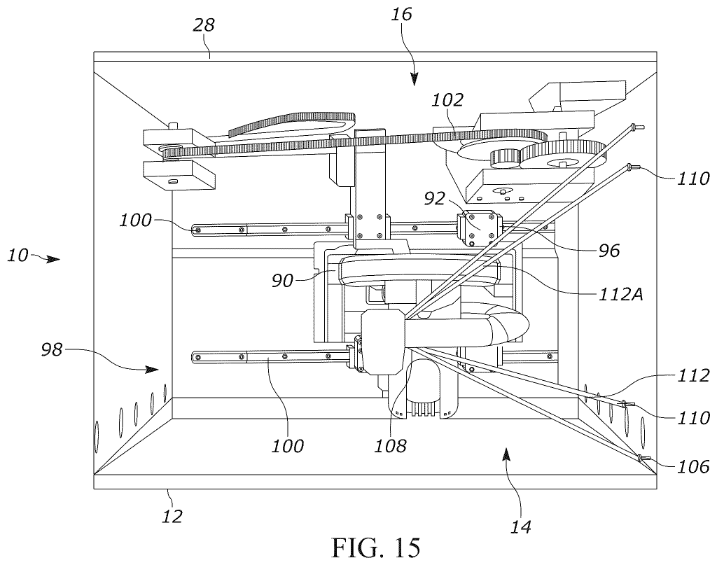

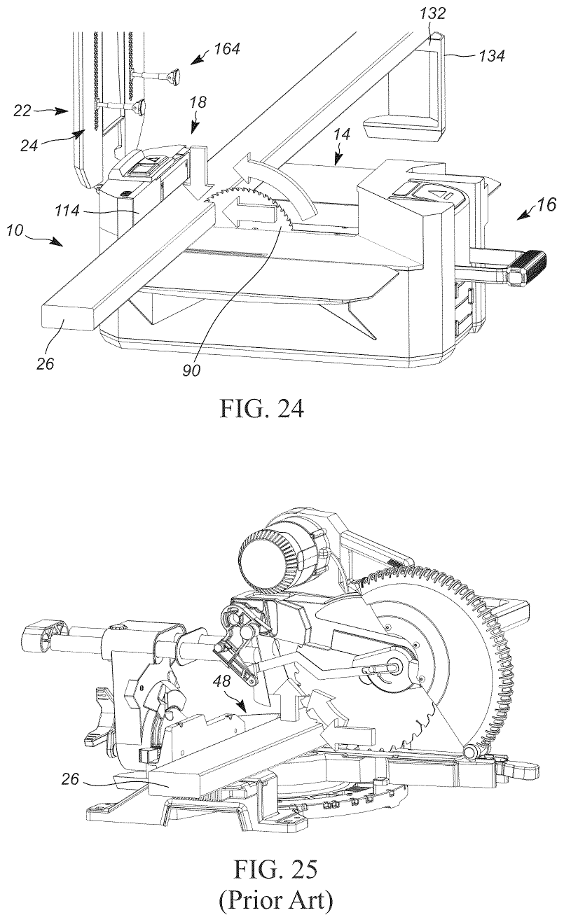

With additional reference to at least FIGS. 15 and 24, the actuation assembly 16 may comprise one or more of a carriage mount 96, a blade path system 98 that may comprise a pair of rails 100 that extend in parallel-spaced alignment with one another, an actuator 102, an actuation control 104, and a bias assembly 106. The carriage mount 96 may connect to the carriage 92 statically or dynamically wherein the latter is configured to allow modification of the position of the saw blade 90. The carriage mount 96 and/or the carriage 92 may be slidably received in the blade path system 98 such as by way of positioned in and between the pair of rails 100. The actuator 102 may extend from a first end 108 to a second end 110. The first end 108 of the actuator 102 may connect to the blade assembly 14 including to the carriage 92 and/or carriage mount 96, and the second end 110 may connect to the actuation control 104. The bias assembly 106 may be connected to and between the housing assembly 12 and the carriage 92 and/or carriage mount 96. The bias assembly 106 may be configured with a bias against the direction of linear explanation of the actuator 102.

In particular aspects, the actuator 102 may be a scissor extender, such as that shown in FIG. 13B, or a belt and gear assembly, such as that shown in FIG. 15. In other aspects, the actuation control 104 may be a handle or a lever, such as that shown in the Figures. In other aspects, the bias assembly 106 may be a spring 112 or a plurality of springs 112A that connect to the blade assembly 14 opposite the connection to the actuator 102 and to the front wall 30 of the enclosure 28.

In this way and with particular reference to FIG. 24, when the actuation control 104 is operated the actuator 102 is configured to expand or otherwise more linearly away from the actuator 102, such as during a rotation of the handle outwardly and in a downward direction as depicted in FIGS. 12 and 22-24. The expansion of the actuator 102 pushes or pulls the blade assembly 14 away such that the blade assembly 14 travels linearly towards the rear wall 32 of the enclosure 28 and linearly away from the actuator 102. Conversely, the bias assembly 106 pushes or pulls the blade assembly 14 towards the front wall 30 and the actuator 102. Accordingly, the actuator 102 may be used to manipulate the position of the blade assembly 14 along a path extending between the front wall 30 and rear wall 32 of the enclosure.

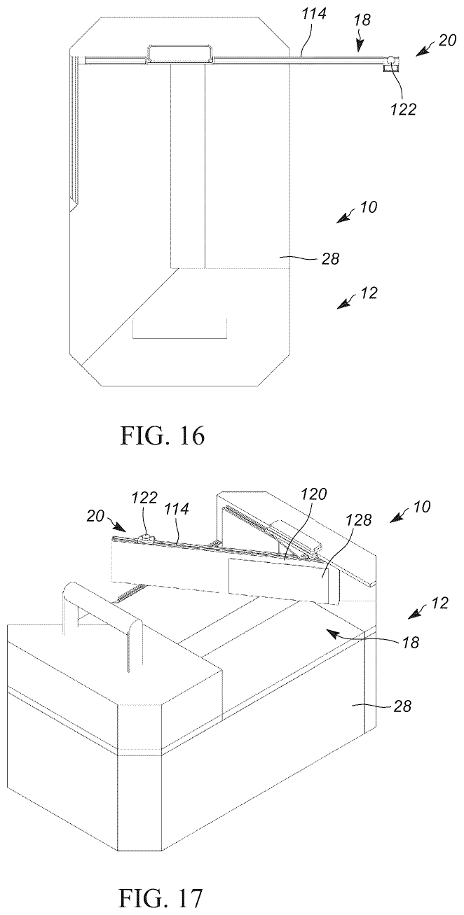

With reference to at least FIGS. 16, 17, 18, 19, 20, 22, and 23, the fence assembly 18 may comprise one or more of a fence 114 that may have a first fence portion 116 and a second fence portion 118, a sacrificial mount 120, and a stop 122. The fence 114 may be connected between the housing assembly 12 and the hood assembly 22 and may be positioned along and above the rear wall 32 of the enclosure 28. The hood assembly 22 may be hingedly connected to the hood assembly 22 such as by way of a hinge 124. The fence assembly 18 is configured to retain the position of the material 26 at a desired angle and length, and to limit or prevent movement about a horizontal plane extending parallel to a length of the material 26 such that a cut is more accurate, precise, and repeatable and may also reduce or prevent tear out as discussed herein. When coupled with the wing 54 and/or second wing 56, the fence assembly 18 allows for a larger max cross cut capacity and angled cross cut capacity, including increased bevel angle.

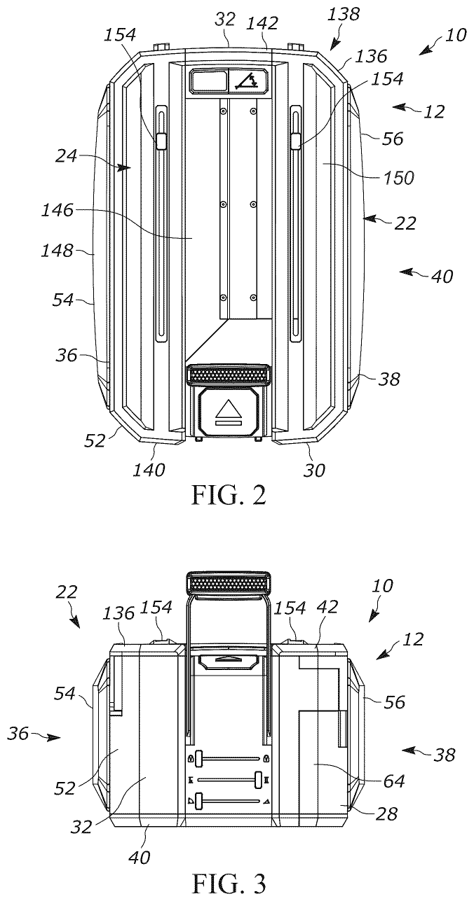

In some aspects and with further reference to at least FIGS. 2, 7, 18, and 19, the display 86 is positioned on the fence 114 and is positioned such that the fence lock 80 and/or display 86 is positioned within a gap 126 of the hood assembly 22 when the hood assembly 22 is in a closed position. In this way the, the display 86 is visible when the hood assembly 22 is opened or closed.

With particular reference to at least FIGS. 16, 17, and 22, the fence 114 may be a single uniform body or comprised of at least the first fence portion 116 and the second fence portion 118. The first fence portion 116 and/or the second fence portion 118 may be rotatably attached to one another such that either or both are rotatable about an axis positioned through the connection with one another. The first fence portion 116 and/or the second fence portion 118 may be rotatable at least 135° with respect to one another from a position where the first fence portion 116 and the second fence portion 118 are in end-to-end parallel alignment with one another as depicted in at least FIGS. 16 and 17.

With further reference to at least FIGS. 6, 12, 17, and 23, the sacrificial mount 120 may be positioned through the fence 114 and is configured to replaceably receive a sacrificial insert 128, such as a strip of medium-density fiberboard (MDF). Before a cut, the sacrificial insert 128 is positioned within the sacrificial mount 120 to reduce or prevent tear out at the end of a cut of the material 26 as the sacrificial insert 128 supports the material 26 throughout the cut. In aspects with the first fence portion 116 and the second fence portion 118, the sacrificial insert 128 allows for zero clearance cuts at any combination of compound angles while maintaining the zero cut path at 90°.

With particular reference to at least FIGS. 16, 18, and 20, the stop 122 may be positioned at an end of the fence 114 and is configured to extend from the fence 114 to engage the material 26 to prevent longitudinal movement of the material 26 during a cut such as by being configured to be received over an end of the material 26. The stop 122 may be rotatable such that the stop 122 may be recessed on and/or within the fence 114 to not engage the material 26 if desired. By preventing movement of the material 26, the stop 122 improves the repeatability of a length of cut of a particular length.

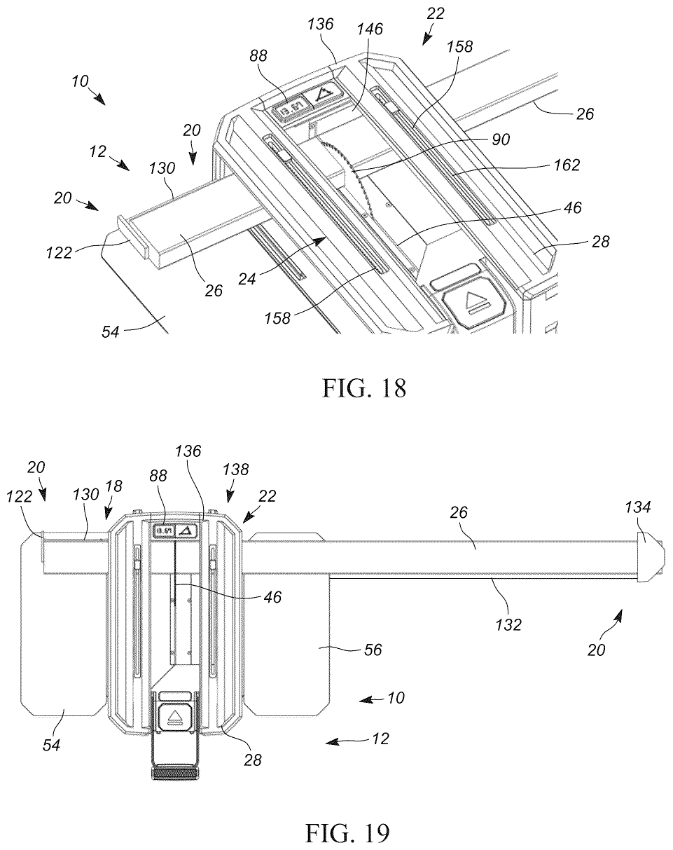

With additional reference to at least FIGS. 18 and 19, the measuring assembly 20 may be connected to the fence assembly 18 or elsewhere on the housing assembly 12 or hood assembly 22. When connected to the fence assembly 18 the measuring assembly 20 may be integrated with the fence 114 or one of either the first fence portion 116 or the second fence portion 118.

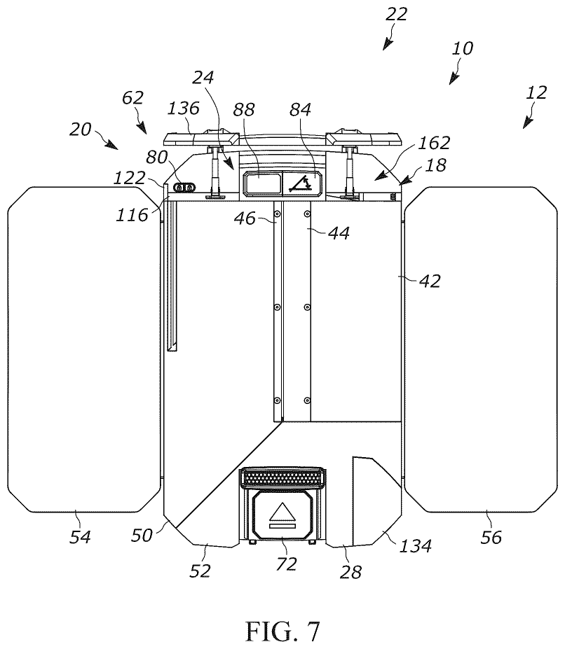

The measuring assembly 20 may comprise one or more of the stop 122, a tape 130, a laser 132, a sensor 134, and the fence lock 80. With reference to FIGS. 7, 16, and 18, the stop 122 may be positioned adjacent an end of the fence 114 with the configuration discussed previously herein. The tape 130 may retractably attached between the fence 114 and the stop 122. The tape 130 may be housed within the fence 114. The tape 130 may be coiled up within the fence 114 and unroll as the stop 122 is moved away from the fence 114. With reference to at least FIG. 19, in addition or alternatively, the fence 114 may contain the laser 132 or the laser 132 may be separate from the fence 114 as depicted in at least FIGS. 6 and 19. When a separate structure, the laser 132 may be stowed in the housing assembly 12. The laser 132 may be configured to emit for detection by the sensor 134 that is positioned a desired distance from the housing assembly 12. The sensor 134 may have the stop 122 or be configured as the stop 122 or an additional instance of the stop 122 as described herein. The laser 132 and the sensor 134 may be present alone or in combination with the tape 130.

The fence lock 80 may be configured to lock one or both of the position of the fence 114 (e.g., the radial relationship between the first fence portion 116 and the second fence portion 118) and the length of the tape 130 such that the material 26 can be repeatedly positioned to perform the same length and angle of cut. The fence lock 80, when the laser 132 is present, may be configured to alert such as by light emission, sound, or pulsating the laser 132, that the stop 122 and therefore the material 26 is not in the position desired when the fence lock 80 was activated.

The display 86 may be configured to display one or more of the distance between a path of the saw blade 90 and the stop 122 as depicted in at least FIG. 18, a distance relative to a path of the saw blade 90 and the tape 130 and/or laser 132, a current angle of the saw blade 90, and a current angle of the first fence portion 116 with respect to the second fence portion 118. In this way, a length of a desired cut and/or angle of a desired cut may be readily ascertainable. Other information may be presented on the display 86 including a current power status of the sawing device 10 or the number of cuts performed since the fence lock 80 was activated.

With reference to at least FIGS. 1, 2, 6, 7, 9, and 12, the hood assembly 22 may comprise one or more of a hood 136, a window assembly 138, and the clamp assembly 24. The hood 136 may be hingedly connected to the housing assembly 12 and/or the fence assembly 18 at a first end 140 and/or latchedly connected to the housing assembly 12 and/or the fence assembly 18 at a second end 142. In this way, the hood 136 can be raised or lowered about the hinged connection between an open and a closed position, and selectively and releasably latched in a closed position such that the hood 136 extends over and partially encloses a space 144 positioned between the housing assembly 12, the blade assembly 14 and the hood assembly 22 from which the material 26 and positioned within and/or through. In some such aspects, the space 144 is enclosed on opposing sides by the guide 50 and the fence 114 as shown in the exemplary embodiment of FIG. 1.

With further reference to at least FIGS. 1, 18, and 19, the window assembly 138 may comprise a window 146 that is translucent or transparent on the hood 136 that is configured to allow the material 26 and the saw blade 90 to be viewable during a cut. The window assembly may comprise a first hood portion 148, the window 146, and a second hood portion 150, wherein each extend from the first end 140 adjacent or abutting the front wall 30 of the housing assembly 12 to the second end 142 adjacent or abutting the rear wall 32 with the window 146 positioned between first hood portion 148 and the second hood portion 150.

With particular reference to at least FIGS. 12, 14B, 20, and 22, and 23, the clamp assembly 24 may comprise one or more of a clamp 152, an adjustable member 154, a channel 156, and a dust blocker 158. The clamp assembly 24 may be configured to hold the material 26 in place by applying a downward force against the material 26 such that the material 26 is held between the clamp assembly 24 and the top wall 42 and/or cutting surface 44.

The clamp 152 may be connected to the hood assembly 22 and extend, at least, partially outwardly and downwardly from the hood assembly 22 such that the clamp 152 is positioned between the hood 136 and the housing assembly 12 when the hood 136 is in a closed positioned. The clamp 152 may be telescopic with a bias, such as through a spring-bias) toward extension such that the clamp 152 is collapsible when sufficient force is applied when the hood 136 is closed and the clamp 152 engages the material 26. In this way, the telescopic configuration of the clamp 152 provides a clamping force on the material 26 given a range of thicknesses.

The clamp 152 may be connected to the adjustable member 154. The adjustable member 154 is configured to transition the clamp 152 to a desired position about the hood 136 that the clamp 152 is in a desired position above and in engagement with material 26. For example, the adjustable member 154 may be used to position the clamp 152 centrally along a width of the material 26 to improve the retention of the material 26 in place. The adjustable member 154 may be positioned through the hood 136 such that a portion 160 of the clamp 152 is positioned above the hood 136 and portion is positioned below the hood 136 when the hood 136 is in a closed position. The adjustable member 154 may be positioned through the channel 156 to permit the adjustable member 154 to travel along a path of the channel 156 and thereby the clamp 152 as well. The channel 156 may have the dust blocker 158 positioned therein to prevent dust from discharging through the hood 136 during a cut. In some aspects, the dust blocker 158 is a plurality of bristles and/or a retractable material connected along the length of the channel 156 and attached to opposing sides of the adjustable member 154.

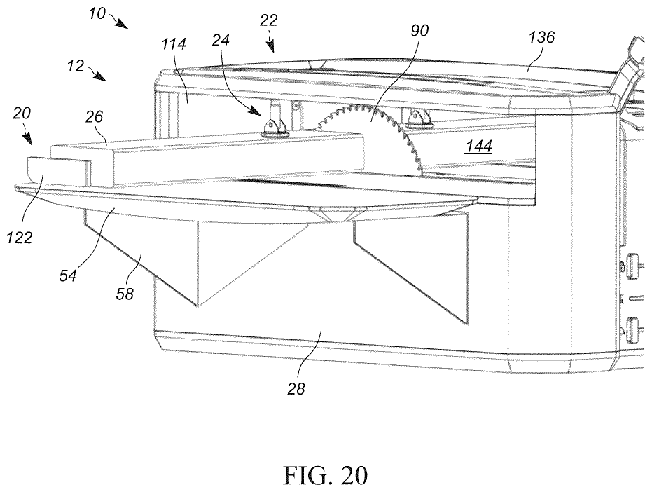

In some aspects, the hood assembly 22 may have a second clamp assembly 162 (or more) as described herein in order to engage the material 26 at multiple positions. In certain aspects, and as seen in at least FIG. 20, the clamp assembly 24 may be positioned on the first hood portion 148 and the second clamp assembly 162 may be positioned on the second hood portion 150.

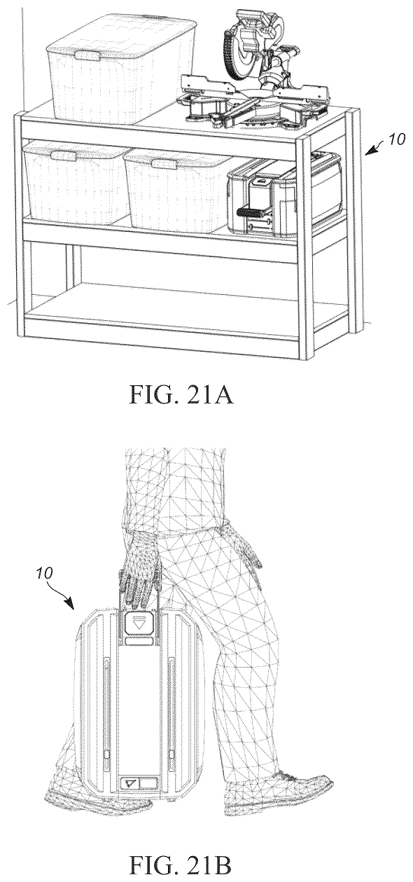

In some aspects and with reference to at least FIGS. 21A-21B, the sawing device 10 is sized and shaped with a compact design such that the sawing device 10 fits on a conventional hardware or home improvement store shelf. In certain such aspects, the sawing device 10, with or without the wing 54 and/or second wing 56 measures no more than sixteen inches across, twelve inches high, and twenty-four inches deep. In such configurations the sawing device 10 is configured to perform cuts at a bevel angle between 0° and 47° with a miter angle between 0° and 46° with the material 26 having a thickness up to two and a half inches with a 90° cut and one and a half inches at a 45° cut, and is capable of a 45° with the material 26 having a capacity or width of up to eight inches.

With reference to FIG. 24, during a cut, the actuation control 104 is leveraged against the bias assembly 106 to propel the blade assembly 14 forward away from the actuation control 104 and towards the fence assembly 18 and the material 26 and returns when the leverage is removed. The saw blade 90 is rotated downwardly and rearwardly with respect to the front wall 30 and the top wall 42, such that when the saw blade 90 engages the material 26 the saw blade 90 pulls the material 26 downwards against the top wall 42 and rearwardly against the fence assembly 18. In this way, the dust 48 discharged from the material 26 is also directed rearwardly and downwardly against the fence assembly 18 while being further contained by the hood assembly 22 such that the dust 48 is captured within the enclosure 28. This operational configuration also applies force on the material 26 downward against the cutting surface 44 and against the fence assembly 18 thereby improving predictability, precision, accuracy, and determinative cutting. The positioning and operation of the actuation control 104 alone and in combination with the operational configuration of the saw blade 90 improves safety as the blade assembly 14, covered by the hood assembly 22, moves away from the actuation control 104 and the rotation of the saw blade 90 is such that any kickback is discharged away from the point of actuation reducing the likelihood of injury, and particularly when the hood assembly 22 is positioned over the cutting surface 44.

This operation contrasts with conventional operation of a saw device such as a miter saw as shown in the prior art of FIG. 25. In the conventional configuration, directs the dust 48 to discharge upwardly and outwardly away from the housing of the saw device. Furthermore, a conventional operation of a saw device can result in a kickback discharging in any direction, and specifically towards the point of actuation as the material 26 may rebound off any fence that may be present.

Therefore, a sawing device 10 has been provided that has a small footprint; can be carried by a single individual; is designed for transport; is precise; is accurate; is precise and accurate during repeated cuts; is accurate during long crosscuts; reduces movement of a material during a cut; reduces or eliminates tear out; accomplishes cuts at a desired length; increases maximum crosscut capacity will a small footprint; is easy to use; is cost-effective for all types of woodworkers; is safe and limits exposure to contact with a saw blade and reduces the likelihood of injury from kickback; provides for linear actuation; captures dust; and improves upon the art.

From the above discussion and accompanying figures and claims it will be appreciated that the sawing device 10 offers many advantages over the prior art. Although the present disclosure and its advantages have been described in detail, it should be understood that various changes, substitutions, modifications, and alterations can be made herein without departing from the technology of the disclosure as defined by the appended claims. The scope of the present application is not intended to be limited to the particular configurations of the process, machine, manufacture, composition of matter, means, methods and steps described in the specification only expressly stated otherwise. As one of ordinary skill in the art will readily appreciate from the disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. A sawing device comprising:
a housing assembly that partially encloses a blade assembly; and
an actuation assembly operatively connected to the blade assembly to move the blade assembly in a linear direction along a substantially horizontal plane.

2. The sawing device of claim 1 further comprising the housing assembly having an enclosure with a cutting surface having a blade slit that a saw blade of the blade assembly is positioned through.

3. The sawing device of claim 1 further comprising a wing rotatably attached to an enclosure of the housing assembly, wherein the wing is configured to transition between a collapsed position wherein the wing engages a side of the enclosure and an expanded position wherein the wing extends in alignment with a cutting surface of the enclosure.

4. The sawing device of claim 3 further comprising a support positioned between the wing and the side of the enclosure, wherein the wing is held in the expanded position by the support.

5. The sawing device of claim 1 further comprising the blade assembly having a carriage, a motor, and a saw blade, wherein the motor is mounted to the carriage and the saw blade is operatively attached to the motor.

6. The sawing device of claim 5 further comprising the actuation assembly having an actuator connected to the blade assembly at a first end and an actuation control at a second end, wherein the actuator is configured to move linearly away from the actuation control upon rotation of the actuation control in a downward direction.

7. The sawing device of claim 6 further comprising a bias assembly connected to the actuation assembly, wherein the bias assembly is configured with a bias against a direction of linear movement of the actuator.

8. The sawing device of claim 6 further comprising the actuation assembly having a blade path system that slidably receive a carriage mount connected to the carriage of the blade assembly.

9. The sawing device of claim 1 further comprising a fence assembly connected to the housing assembly.

10. The sawing device of claim 9 further comprising the fence assembly having a first fence portion that is rotatably attached to a second fence portion of the fence assembly such that the first fence portion is rotatable radially at least 135° about a connection between the first fence portion and the second fence portion.

11. The sawing device of claim 10 further comprising the fence assembly having a fence lock configured to lock the first fence portion in position.

12. The sawing device of claim 9 further comprising the fence assembly having a sacrificial mount that replaceably receives a sacrificial insert.

13. The sawing device of claim 9 further comprising the fence assembly having a measuring assembly attached to a fence portion, and the measuring assembly having a tape that retractably attaches between a stop and the fence portion, wherein the stop is configured to be received over an end of a material.

14. The sawing device of claim 12 further comprising a display connected to the housing assembly, wherein the display is configured to display a length of a desired cut.

15. The sawing device of claim 1 further comprising a hood assembly hingedly attached to the housing assembly.

16. The sawing device of claim 15 further comprising a fence assembly positioned between the hood assembly and the housing assembly.

17. The sawing device of claim 15 further comprising the hood assembly having a hood having a window assembly comprised of a first hood portion, a window, and a second hood portion that each extend from a front wall to a rear wall of the housing assembly.

18. The sawing device of claim 15 further comprising the hood assembly having a clamp assembly that extends between the hood assembly and the housing assembly.

19. The sawing device of claim 1 further comprising the blade assembly having a saw blade, wherein the saw blade is rotatable downwardly and rearwardly with respect to a front wall and top wall of the housing assembly, wherein when the saw blade engages a material the saw blade pulls the material downward against the top wall of the housing assembly and towards a fence assembly connected to the housing assembly.

20. The sawing device of claim 19 wherein when the saw blade engages the material a dust from the material is directed rearwardly against the fence assembly between a hood assembly and the housing assembly such that the dust is captured within the housing assembly.
